(19) United States
(12) Patent Application Publication
(10) Pub. No.: US 2015/0197045 A1
(43) Pub. Date: Jul. 16, 2015

(54) METHOD FOR MANUFACTURING MAGNETIC ROLLERS AND SYSTEM THEREOF

(71) Applicant: EARTH MAGNETS (HONG KONG) COMPANY LIMITED, New Territories (HK)

(72) Inventors: Ching Chi MOK, New Territories (HK); Lai Ping Lo, New Territories (HK); Zi He YONG, New Territories (HK); Hai Zhan LAO, New Territories (HK)

(73) Assignee: EARTH MAGNETS (HONG KONG) COMPANY LIMITED, New Territories (HK)

(21) Appl. No.: 14/152,992

(22) Filed: Jan. 10, 2014

(51) Int. Cl. B29C 45/00; B29D 99/00

(52) U.S. Cl. CPC B29C 45/0001; B29D 99/0032; B29K 2477/00

(57) ABSTRACT

A method for manufacturing magnetic rollers and a system thereof, wherein the method comprises the following steps: Step 1: determining number and shape of magnets required according to a desired magnetic field distribution diagram, and thereafter mounting the magnets around a cavity of a mold at corresponding positions required for attaining the desired magnetic field distribution diagram; Step 2: injecting materials for manufacturing the magnetic roller into the cavity of the mold; at the same time, magnetizing the magnetic roller inside the mold so that the magnetic roller manufactured has a magnetic field distribution diagram identical to the desired magnetic field distribution diagram mentioned in Step 1. The system used in the method for manufacturing magnetic rollers comprises a mold, wherein the mold comprises a cavity and magnets; the magnets are distributed around the cavity of the mold according to a desired magnetic field distribution diagram.

### BACKGROUND OF THE INVENTION

The present invention relates to technology for manufacturing magnetic rollers and more particularly pertains to a method for manufacturing magnetic rollers and a system thereof.

With the increase in office automation, the application of equipment such as copiers, printers and fax machines is becoming more common. In the developing technology adopted by equipment such as copiers, printer's and fax machines, magnetic rollers are regarded as an indispensable component which plays an important role. The quality of magnetic rollers will directly affect the copying and printing quality. The quality of magnetic rollers is mainly determined by their manufacturing technology and equipment. At present, there are mainly two methods for manufacturing magnetic rollers, namely adhesion and integral molding. To manufacture magnetic rollers by adhesion, a number of permanent magnetic strips are adhered onto a mandrel to form a magnetic roller. A magnetic roller formed by adhesion has the following disadvantages: it has unstable quality and high defective rate because it is formed by adhering independent permanent magnetic strips which have different compositions and are made by different manufacturing methods; besides, it has high production costs and requires long processing time because special clamps and adhesives are required for adhering the permanent magnetic strips and assembly is required after the adhesion process; furthermore, due to the differences in the characteristics of each of the permanent magnetic strips, difficulties are encountered in material selection, shaping and sizing, and repeated trials are ten needed to manufacture deal magnetic rollers, thus resulting in long production time. As for the integral molding method used for manufacturing magnetic rollers in the marketplace, magnetic rollers are formed by injection molding, and the magnet rollers formed by injection molding will then undergo demagnetization and magnetization processes to attain specific magnetic pole strength, magnetic angle and so forth. However, r magnetic rollers manufactured by injection molding in the present marketplace have equal strengths and widths for each magnetic pole; it is impossible to manufacture magnetic rollers with different strengths and widths for each magnetic pole according to customers' requirements. Due to the fact that magnetic rollers having equal strengths and widths for each magnetic pole can only be used in printers but not copiers, the application scope of magnetic rollers formed by injection molding is still limited.

### BRIEF SUMMARY OF THE INVENTION

To overcome the disadvantages and shortcomings of the prior art, the present invention provides a method for manufacturing magnetic rollers with the following advantages: simple manufacturing process, short production cycle, high production efficiency, low production costs, energy-saving, capable of magnetizing magnetic rollers according to specific requirements during injection molding, and easy to attain complex magnetic flux density diagrams.

Another object of the present invention is to provide a system which can achieve the aforementioned method for manufacturing magnetic rollers. The system of the present invention is simple and reasonable in structure, convenient to operate, easy to control and has lower production costs; magnetic rollers manufactured have the advantages of low production costs and stable quality.

The primary object of the present invention is achieved by providing a method for manufacturing a magnetic roller which comprises the following steps:

Step 1: determining number and shape of magnets required according to a desired magnetic field distribution diagram, and thereafter mounting the magnets around a cavity of a mold at corresponding positions required for attaining the desired magnetic field distribution diagram;

Step 2: injecting materials for manufacturing the magnetic roller into the cavity of the mold for molding to manufacture the magnetic roller; at the same time, magnetizing the magnetic roller inside the mold so that the magnetic roller manufactured has a magnetic field distribution diagram identical to the desired magnetic field distribution diagram mentioned in Step 1.

A metallic mandrel is embedded in the magnetic roller formed by injection molding mentioned in Step 2 to enhance mechanical strength of the magnetic roller.

If magnetic flux density of the magnetic roller taken out from the mold does not meet desired requirements, the magnetic roller taken out from the mold can be demagnetized and thereafter magnetized again to meet the desired requirements.

If the magnetic flux density of the magnetic roller taken out from the mold meets the desired requirements, but at least one pole needs to form a special wave pattern, a groove cutting operation can be performed at a position of the magnetic roller corresponding to the special wave pattern after the magnetic roller has been taken out from the mold so as to form a special magnetic field distribution wave pattern which meets the special requirements of the special magnetic field distribution requirements. It can be seen that the present invention can manufacture magnetic rollers with extremely complex wave patterns in their magnetic field distribution diagrams.

Apart from performing a groove-cutting operation at the magnetic roller formed by injection molding to form special magnetic field distribution wave pattern, shape of the cavity of the mold can also be configured according to the special magnetic field distribution wave pattern before injection molding, so that the magnetic roller formed by injection molding has a cross-section comprising concave-convex portions.

The magnetic roller as mentioned in Step 2 can optionally be disposed with a metallic mandrel at center thereof. Materials used for manufacturing the magnetic roller can be combined particles of PA+Fe.

Another object of the present invention is achieved by providing a system used in the method for manufacturing magnetic rollers which comprises a mold, wherein the mold comprises a cavity and magnets; the magnets are distributed around the cavity of the mold according to a desired magnetic field distribution diagram.

The magnets can be permanent magnets or electromagnets. Number of the magnets can range from 2 to 10 pieces.

The cavity of the mold can be cylindrical in shape, but other shapes are also possible depending on actual production needs.

In comparison with the prior art, the present invention has the following advantages and effects:

(1) The present invention uses magnetic rollers roared by integral molding to replace magneto rollers formed by adhesion. Not only is the adhesion process exempted, tools, materials and time required for the adhesion process are also saved. As a result, the present invention has the advantages of low production costs and short production time.

(2) The magnetic rollers of the present invention can comprise a plurality of magnets. Strengths and magnetic angles for each magnetic pole are different from each other. Therefore, not only can the magnetic rollers of the present invention be used in printers, but they can also meet requirements of copiers. Hence, the application scope is broader.

(3) In the method for manufacturing magnetic rollers of the present invention, orientation process is carried out to attain stronger magnetic strength.

(4) With the method for manufacturing magnetic rollers of the present invention, the magnetic rollers can be assembled for use directly after infection molding if there are no special requirements for the wave patterns of the magnetic poles of the magnetic rollers. If there are special requirements, the magnetic rollers can be demagnetized and thereafter magnetized again by specific clamps. Shapes of the wave patterns of the magnetic poles can also be modified by mechanical processing. Therefore, the present invention has the advantages of low production costs, short production time, easy modification, and being flexible and adaptable.

### BRIEF DESCRIPTION OF THE DRAWINGS

FIG. 1 is a schematic diagram showing the positions of magnets inside the mold in Embodiment 1.

FIG. 2 is a schematic diagram showing the desired magnetic field distribution in Embodiment 1.

FIG. 3 is a schematic diagram showing the positions of magnets inside the mold in Embodiment 2.

FIG. 4 is a schematic diagram showing the magnetic field distribution of the magnetic roller taken out from the mold in Embodiment 2.

FIG. 5 is a schematic diagram showing the desired magnetic field distribution in Embodiment 2.

FIG. 6 is a schematic diagram showing the positions of magnets inside the mold in Embodiment 3.

FIG. 7 is a schematic diagram showing the desired magnetic field distribution in Embodiment 3.

FIG. 8 is a schematic diagram showing the magnetic roller after the groove-cutting operation is Embodiment 3.

FIG. 9 is a schematic diagram showing the magnetic roller embedded with the metallic mandrel in Embodiment 4.

FIG. 10 is a schematic diagram showing the positions of magnets inside the mold in Embodiment 5.

FIG. 11 is a schematic diagram showing the desired specific magnetic field distribution in Embodiment 5.

FIG. 12 is a perspective view showing the magnetic roller after injection molding in Embodiment 5.

### DETAILED DESCRIPTION OF THE INVENTION

The present invention will further be described in details below with reference to the embodiments and accompanying figures. However, the embodiments of the present invention are not limited thereto.

### EMBODIMENT 1

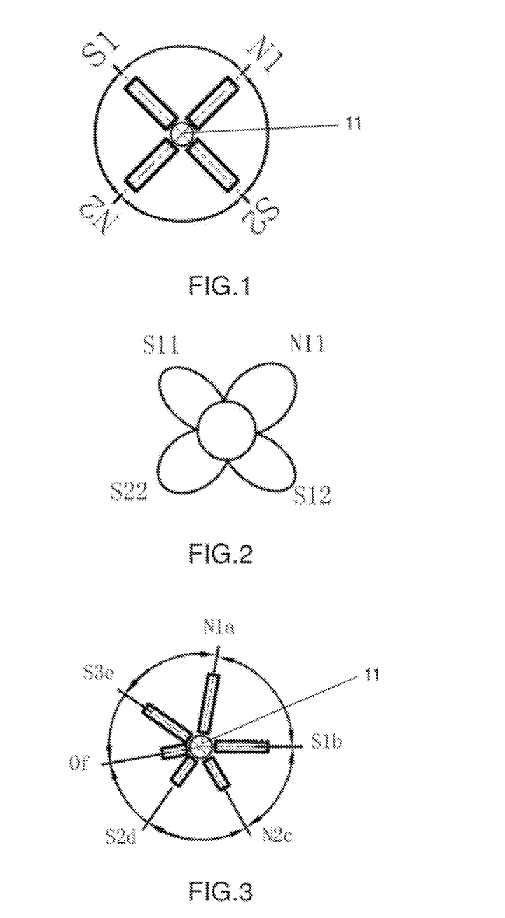

As illustrated in FIGS. 1 and 2, the method for manufacturing a magnetic roller comprises the following steps:

Step 1: According to a desired magnetic field distribution diagram as illustrated in FIG. 2 (i.e. a total of four magnetic poles with magnetic flux density of each magnetic pole being 135 mT±5 mT and angle between each magnetic pole being 90 degrees), it is determined that four magnets are required and that the four magnets are substantially identical shape and size; mount the magnets around a cavity of a mold, and symmetrically and evenly distribute the magnets around the cavity along a symmetrical axis being a central axis of the cavity; the mounting position of the magnetic roller is illustrated in FIG. 1;

Step 2: Inject materials for manufacturing the magnetic roller into the cavity for molding to manufacture magnetic roller; at the same time, the magnetic roller is magnetized by the magnets so that the magnetic roller manufactured has a magnetic field distribution diagram identical to the desired magnetic field distribution diagram mentioned in Step 1.

In this embodiment and other embodiments of this specification, Neodymium-Iron-Boron can be used as the magnets. Magnetization will be automatically performed by Neodymium-Iron-Boron without the need of temperature control and adjustment of magnetic strength, time and so forth. However, different models of materials are selected according to the magnetic strengths required. In this embodiment, N38SH model of Neodymium-Iron-Boron is selected. Each of the magnets has a length identical to that of the magnetic roller (for example, 210 mm or 300 mm), a width of 30 mm and a height of 8 mm. In this embodiment, the magnets are permanent magnets; but in other embodiments, electromagnets can also be used, wherein a magnetic yoke inside an electromagnetic coil is used to adjust voltage and size of electric current to suitable levels to produce magnetic poles.

The magnetic roller as mentioned in Step 2 can optionally be disposed with a metallic mandrel at center thereof. Materials used for manufacturing the magnetic roller can be combined articles of PA+Fe.

As illustrated in FIG. 2, since the four poles N11, S11, N12 and S22 have very similar magnetic flux densities, and the angles between each adjacent pair the poles of the magnets in the mold are each around ninety degrees, the magnetization of the magnetic roller can be completed inside the mold.

As illustrated in FIG. 1, a system for manufacturing magnetic rollers comprises a mold, wherein the mold comprises a cylindrical cavity 11; the mold further comprises four permanent magnets N1, S1, N2 and S2; the magnets are distributed around the cavity 11 of the mold according to a desired magnetic field distribution diagram. FIG. 1 is a cross-sectional diagram of the system. In this embodiment, the mold has a frame made of iron and a plate made of stainless steel.

### EMBODIMENT 2

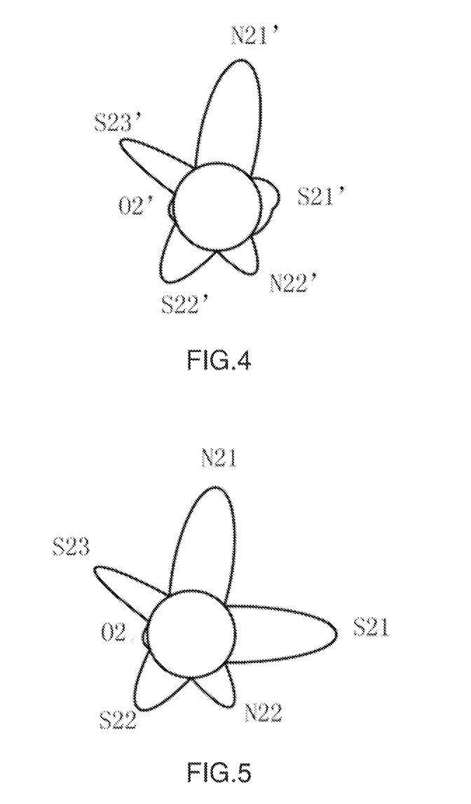

Apart from characteristics mentioned below, this embodiment is the same as Embodiment 1: As illustrated in FIG. 5, the magnetic flux densities of the six poles N21, S21, N22, S22, O2 and S23 are 90 mT, 80 mT, 40 mT, 50 mT, 10 mT and 60 mT respectively, wherein spacing between positions of the magnetic poles are not equal and differ greatly from each other. Therefore, number and shape of the magnets together with their positions inside the mold have all to be disposed according to the desired magnetic field distribution diagram as illustrated in FIG. 5. As illustrated in FIG. 3, six magnets N1a, S1b, N2c, S2d, 0f and S3e of different sizes are asymmetrically distributed around the cavity 11. The magnets each has a length identical to that of the magnetic roller (for example, 210 mm or 300 mm), a width of 8 mm, 20 mm, 10 mm, 10 mm and 10 mm respectively, and a height of 30 mm, 25 mm, 10 mm, 15 mm, 5 mm and 20 mm respectively. Although the desired requirements are as illustrated in FIG. 5, due to errors occurred during the manufacturing process and other reasons, the magnetic flux densities of the six poles N21′, S21′, N22′, O2′ and S23′ of the magnetic roller taken out from the mold, as illustrated in FIG. 4, are detected to be different from the desired requirements as illustrated in FIG. 5. Hence, the magnetic roller taken out from the mold has to undergo demagnetization and thereafter unsaturated magnetization mail it attains the desired magnetic flux density as illustrated in FIG. 5. After demagnetization and magnetization, the magnetic, field distribution diagram meets the desired requirements illustrated in FIG. 5, thereby correcting the errors occurred during the production process, in this embodiment, a magnetizing cabinet can be used for magnetizing the magnetic roller: the magnetizing cabinet comprises a capacitor which can generate 6 sets of power outputs by means of a controller. These 6 sets of power outputs can generate various magnetic strengths by adjusting the voltage in order to magnetize each magnetic pole of the magnetic roller respectively. As such, different magnetic flux densities can be attained at different positions at the magnetic roller.

### EMBODIMENT 3

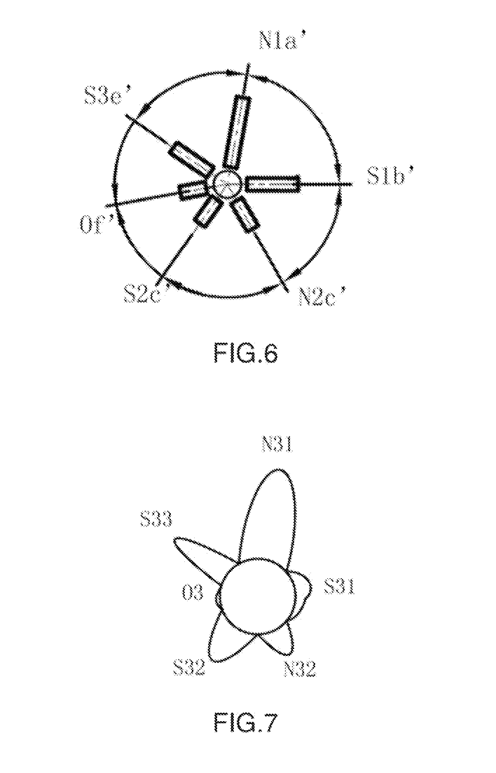

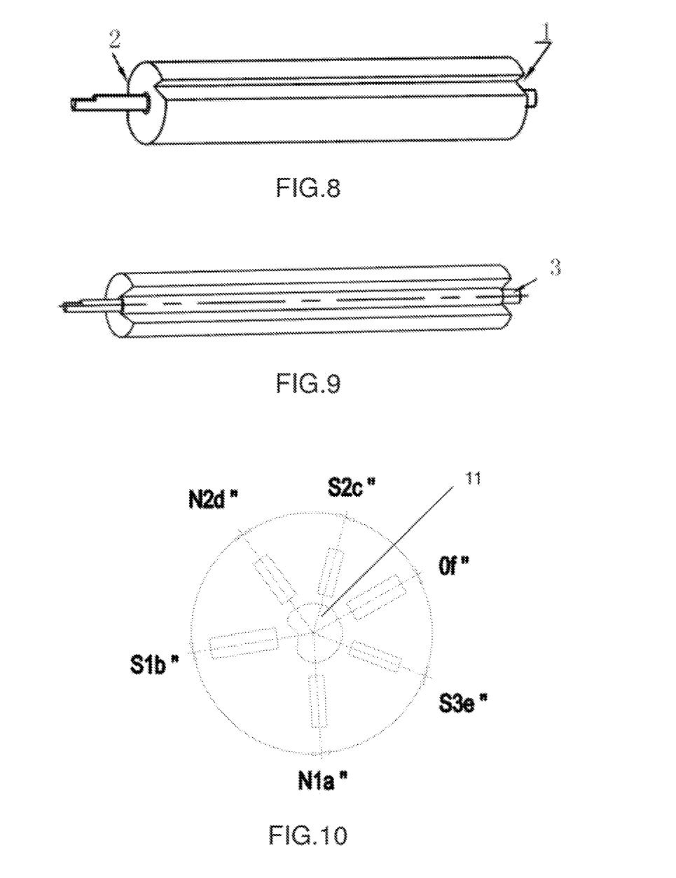

Apart from the characteristics mentioned below, this embodiment is the same as Embodiment 1: As illustrated in FIG. 7, the magnetic flux densities of the six poles N31, S31 N32, S32, O3 and S33 of the desired magnetic field distribution diagrams required are basically the same as those in Embodiment 2, except that there are two values in the pole S31 which are 40 mT and 20 mT respectively. Positions of the magnetic poles are all asymmetrical and shape of each pole differs from each other greatly. Therefore, number and shape of the magnets together with their positions in the mold have to be disposed according to the desired magnetic field distribution diagram as illustrated in FIG. 7. As illustrated in FIG. 6, six magnets N1a′, S1b′, N2c′, S2c′, Of′ and S3e′ of different sizes are asymmetrically distributed around the cavity of the mold, the sizes of magnets are the same those in Embodiment 2. Although the magnetic flux densities of the six poles magnetic roller taken out from the mold have already met the desired requirements, the pole S31 as shown in FIG. 7 has a very special wave pattern with a recessed portion. Therefore, after the magnetic roller is taken out from the mold, as illustrated in FIG. 8, a groove 1 is cut on the magnetic roller at position corresponding to the recessed portion of the wave pattern of the pole S31 using a datum plane 2 as the datum plane. After the groove-cutting operation, the magnetic miler can form a special magnetic field distribution wave pattern which meets the desired requirements as illustrated in the magnetic field distribution diagram in FIG. 7, resulting in a magnetic roller which has an extremely complex wave pattern in its magnetic field distribution diagram.

### EMBODIMENT 4

Apart from the characteristics mentioned below, this embodiment is the same as Embodiment 1, Embodiment 2 and Embodiment 3. As illustrated in FIG. 9, in order to enhance mechanical strength of the magnetic roller, a metallic mandrel 3 is embedded inside the magnetic roller formed by injection molding to overcome the disadvantage regarding the fact that magnetic rollers are easily damaged by external force. This helps enhance the durability of the magnetic rollers.

### EMBODIMENT 5

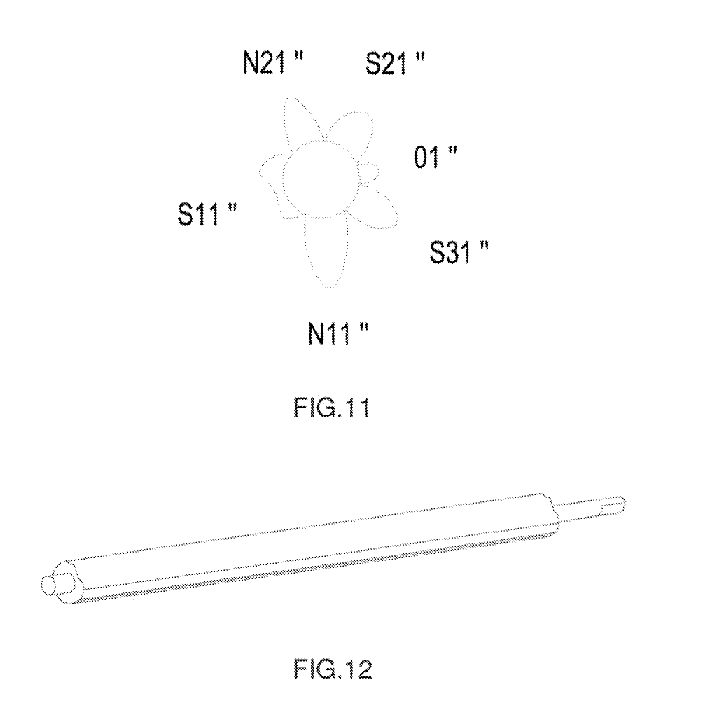

Apart from the characteristics mentioned below, this embodiment is the same as Embodiment 1. As illustrated in FIG. 11 the magnetic flux densities of N21″, S21″, 01″, S31″ and N11″ are 40 mT, 50 mT, 15 mT, 60 mT and 90 mT respectively. There are two peak values in the pole S11″ which are 60 mT and 30 mT respectively. Positions of these r magnetic poles are not the same and differ greatly from each other. Therefore, number and shape of the magnets together with their positions inside the mold have all to be disposed according to the desired magnetic field distribution diagram as illustrated in FIG. 10. As illustrated in FIG. 10, six magnets S2c″, 0f″, S3e″, N1a″, S1b″ and N2d″ of different sizes are asymmetrically distributed around the cavity 11. The magnets each has a length identical to that of the magnetic roller (for example, 210 mm or 300 mm), a width of are 8 mm, 15 mm, 10 mm, 8 mm, 25 mm and 12 mm respectively, and a height of 20 mm, 10 mm, 10 mm, 30 mm, 25 mm and 20 mm respectively. Since the wave pattern of the pole S11″ is special, the shape of the cavity 11 can be modified correspondingly to meet the requirements of the wave pattern of the pole S11″, so that the magnetic roller formed by injection molding has a cross-section comprising concave-convex portions (as illustrated in FIG. 12). Instead of performing groove-cutting operation at the magnetic roller after injection molding as in Embodiment 3, the present embodiment modifies the shape of the cavity of the mold; this has the advantages of material saving and costs reduction.

From the above embodiments, it could be understood that the characteristics of the method for manufacturing magnetic rollers of the present invention lies in the use of a mold which is mounted with a plurality of magnets to magnetize magnetic rollers simultaneously during injection molding. Magnetic rollers with various magnetic poles can be manufactured by integral molding. Different desired magnetic field distribution diagrams can be attained by arranging magnets of different sizes at different positions of the cavity of the mold, performing different groove-cutting operations or carrying out demagnetization and magnetization processes. However, to a person skilled in the art of the present invention, it is possible to obtain the best specific parameters for the following according to the teaching of this specification and through standard testing: arrangements of different magnets around the cavity of the mold according to different desired magnetic field distribution diagrams, the groove cutting operation at the magnetic roller after molding in order to obtain a special magnetic field distribution wave pattern, or modification of the shape of the cavity of the mold to replace the groove-cutting operation, which is carried out after the molding of magnetic rollers, to obtain magnetic rollers with special magnetic field distribution wave pattern and so forth.

The above embodiments are preferred embodiments of the present invention. However, the embodiments of the present invention are not limited by the above embodiments. Any other changes, modification, substitution, combinations and simplification not deviated from the spiritual essence and principle of the present invention are equivalent replacements and they all fall into the scope of protection of the present invention.

What is claimed is:

1. A method for manufacturing a magnetic roller, wherein the method comprises the steps of:
Step 1: determining number and shape of magnets required according to a desired magnetic field distribution diagram, and thereafter mounting the magnets around a cavity of a mold at corresponding positions required for attaining the desired magnetic field distribution diagram;
Step 2: injecting materials for manufacturing the magnetic roller into the cavity of the mold for molding to manufacture the magnetic roller; at the same time, magnetizing the magnetic roller in the mold so that the magnetic roller manufactured has a magnetic field distribution diagram identical to the desired magnetic field distribution diagram mentioned in Step 1.

2. The method for manufacturing a magnetic roller as in claim 1, wherein the magnetic roller taken out from the mold after molding as mentioned in Step 2 has to be demagnetized and thereafter magnetized again.

3. The method for manufacturing a magnetic roller as in claim 2, wherein a magnetizing cabinet can be used for magnetizing the magnetic roller; the magnetizing cabinet comprises a capacitor which can generate, by means of a controller, a plurality of power outputs whose number corresponds to number of magnetic poles of the desired magnetic field distribution diagram; the plurality of power outputs can generate various magnetic strengths by adjusting voltages in order to magnetize each magnetic pole of the magnetic roller respectively; as such, different magnetic flux densities can be attained at different positions of the magnetic roller.

4. The for method for manufacturing a magnetic roller wherein groove-cutting operation is performed on a surface of the magnetic roller after the magnetic roller after molding in Step 2 has been taken out from the mold.

5. The method for manufacturing a magnetic roller as in claim 1, wherein shape of the cavity of the mold is configured before Step 1 according to the desired magnetic field distribution diagram with one or more poles having irregular wave patterns, so that the magnetic roller formed by injection molding has a cross se bon comprising concave-convex portions.

6. The method for manufacturing a magnetic roller as its claim 1, wherein the magnetic roller mentioned in Step 2 can be disposed with a metallic mandrel at center thereof.

7. The method for manufacturing a magnetic roller as in claim 1, wherein materials used for manufacturing the magnetic roller in Step 2 are combined particles of PA+Fe.

8. The method for manufacturing a magnetic roller as claim 1, wherein a metallic mandrel is embedded inside the magnetic roller formed by injection molding in Step 2.

9. The method for manufacturing a magnetic roller as in claim 2, wherein a metallic mandrel is embedded inside the magnetic roller formed by injection molding in Step 2.

10. The method for manufacturing a magnetic roller as claim 3, wherein a metallic mandrel is embedded inside the magnetic roller formed by injection molding in Step 2.

11. The method for manufacturing a magnetic roller as in claim 4, wherein a metallic mandrel is embedded inside the magnetic roller formed by injection molding in Step 2.

12. The method for manufacturing a magnetic roller as in claim 5, wherein a metallic mandrel is embedded inside the magnetic roller formed by injection molding in Step 2.

13. The method for manufacturing a magnetic roller as in claim 7, wherein a metallic mandrel is embedded inside the magnetic roller formed by injection molding in Step 2.

14. A system used in the method for manufacturing magnetic rollers which comprises a mold, wherein the mold comprises a cavity and magnets; the magnets are distributed around the cavity of the mold according to a desired magnetic field distribution diagram.

15. The system used in the method for manufacturing magnetic rollers as in claim 14, wherein the magnets are permanent magnets or electromagnets; number of the magnets ranges from 2 to 10 pieces.
